(19) United States
(12) Patent Application Publication
(10) Pub. No.: US 2007/0074550 A1
(43) Pub. Date: Apr. 5, 2007

(54) Lock

(75) Inventor: Paul Nicholas Roger Isaacs, Buckinghamshire (GB)

Correspondence Address: WITHROW & TERRANOVA, P.L.L.C., 100 REGENCY FOREST DRIVE, SUITE 160, CARY, NC, 27518, US

(73) Assignee: Ison Limited, Buckinghamshire (GB)

(21) Appl. No.: 10/578,030

(22) PCT Filed: Nov. 4, 2004
(86) PCT No.: PCT/GB04/04647

§ 371 Date: May 2, 2006

(30) Foreign Application Priority Data
Nov. 4, 2003 (GB) GB 0325682.3

(51) Int. Cl. E05B 47/00

(52) U.S. Cl. 70/279.1

(57) ABSTRACT

A lock comprises a shield in the form of a cover (1) which extends over the mechanism of the lock and a staple (7) engaged by the lock, preventing access to the mechanism of the lock and to the staple by tools such as bolt cutters. The lock is preferably electronically operated containing electronic circuitry therein and the cover provides a protective housing for the circuitry, battery and an antenna (6) associated with the circuitry.

The present invention relates to a lock, and in particular, but not exclusively, to an electronic lock suitable for cabinets, gates and doors, where authorised individuals need to gain access.

Existing locking devices, such as padlocks, with hasps and staples are well known, but suffer from the disadvantage that they are physically exposed to criminal attack, vandalism and environmental issues, such as water penetration.

Padlocks provide access to individuals who normally have the same encoded ‘key’ or the like. Therefore if a key is lost or stolen the security is compromised. The present solution would be to replace it with a new lock, which would have different encoded keys.

The present invention can allow for the ‘intelligent’ aspect of the lock to be re-programmed in the event of key loss to prevent access by individuals with unauthorised keys.

With reference to physical attack, new advanced types of cutting tools and machines are now available to criminals that have reduced the protection that traditional padlocks once provided.

The object of this invention is to provide a lock capable of overcoming disadvantages of existing locking devices.

According to the present invention there is provided a lock comprising a lock mechanism arranged to receive and lock to an associated keep, characterised in that the lock comprises an outer cover which extends over both the lock mechanism and the keep when the keep is locked to the lock and in that the cover prevents access to both the lock mechanism and the keep.

By employing a lock in accordance with the present invention, the lock mechanism and keep are completely shielded by the cover preventing access to both the keep and the mechanical mechanism of the lock preventing tools such as bolt cutters being engaged upon components of the lock.

Preferably, the components of the lock mechanism which retain the keep in a locked position within the lock are located within the lock and the lock cover is profiled such that a cutting or grinding disk extending in excess of 20 mm from the body of a cutter (for example an angle grinder) would be required to server those components. Such a lock is resistant to attack by standard size cutting disks employed with battery operated angle grinders that are now commonly available.

Preferably, the cover comprises dissimilar material selected to resist cutting by a cutting disk. It is well known that dissimilar materials can be selected to clog conventional cutting disks. The cover may comprise ceramic inserts attached thereto, hardened steel inserts or other hard materials. The lock cover may be cast and have at least one surface hardened.

Preferably, the cover not only protects the lock from being tampered with but also protects the lock from the weather, particularly rain

Advantageously, the lock mechanism comprises electronic circuitry and mechanical elements controlled by the electronic circuitry. Preferably, the electronic circuitry comprises a keypad aligned with an aperture in the cover permitting the lock to be operated when a correct code is entered and/or comprises a receiver for receiving a signal externally of the cover and permits the lock to be operated when a correct signal is received. A convenient ‘electronic key’ would be a ‘smart card’ which employs electronic circuitry which may transmit a code while being inductively coupled to the receiver by being placed in close proximity thereto.

Preferably, the lock comprises a mechanical linkage which extends through the cover of the lock such that the linkage can be actuated by a user, wherein the lock is arranged such that on receipt of a correct code or signal the electronic circuitry enables the lock to be released by the user operating the mechanical linkage, such that the energy required to lock or release the lock is supplied by the user. Such an arrangement ensures that any large amounts of energy required to lock or release the lock, which may be necessary due to misalignment of the lock relative to the keep, or due to corrosion of the keep, is provided by the user and therefore any electromechanical components of the lock need only draw mininum power to release components within the lock so that the user may ultimately lock or release the keep from the lock.

Preferably, the electronic circuitry comprises a wake-up mode which is actuated by the user first operating the mechanical linkage, this enabling the electronic circuitry and particularly the receiver to completely shut down, minimising the power requirements of the lock.

Preferably, the mechanical linkage comprises a cylinder lock arranged to release the lock manually when operated by the correct key, this providing a manual override in failure of the power supply of the lock, the electronic circuitry or other components of the lock such as an antenna or keypad.

The functions and advantages of electronic of ‘intelligent’ locks are well known, most of which would also be applicable to a lock in accordance with the present invention. The advantages of this new lock would be too numerous to list here, but by way of illustration the lock may, for example, be programmed as follows:

(i) To provide single point access to many users - to electronically programme out of the system lost or stolen ‘keys’.

(ii) To provide an audit trail for the opening and closing of the lock.

(iii) To transmit information and data over distances through the air by wireless means.

In a preferred embodiment, this invention may provide a lock case, which is secured to a moving door, on a cabinet moving door, or moving gate. It provides a keep, typically in the form of a staple, which is fixed to the corresponding matching opposite door or fixed post, or door jamb. A sprung-loaded security bolt integrated within the lock case which engages and disengages with the keep to secure and un-secure the lock. A deadlock pin can be internally mounted to secure and release the security bolt. A motorised actuator powered by an electric circuit with an integrated transceiver is connected to receiving and transmitting antenna The antenna will be capable of receiving an authorised signal from an electronic programmable card sometimes referred to as a ‘smart card’. A battery pack would supply external electrical power to the circuitry. There will be connections to receive electrical power by external means as another option.

Preferably, the lock-case is made of steel, which can be hardened to resist physical attack such as drilling and cutting with conventional tools. Dissimilar materials such as aluminium and plastic may be added to enhance the physical strength against grinding and to provide electrical insulation.

Two embodiments of the present invention are described below, by way of example only, with reference to the accompanying drawings, in which:

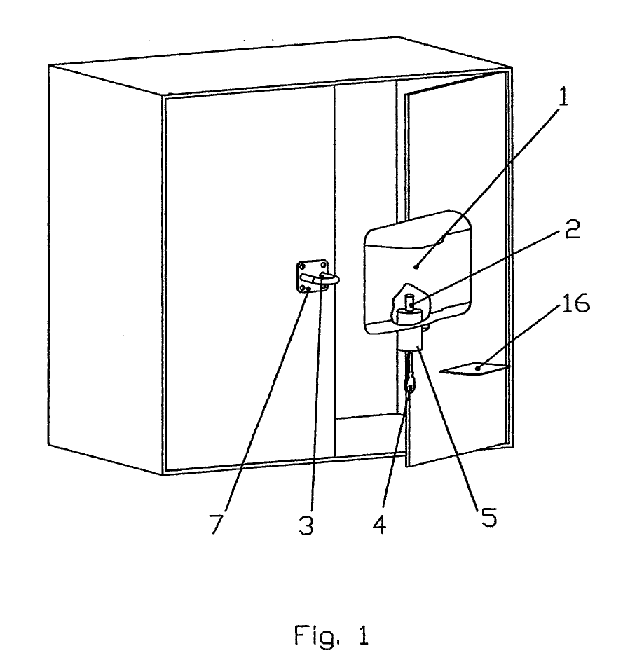

FIG. 1 is a perspective view of a lock in accordance with a first or second aspect of the invention, secured to a moving leaf of a cabinet;

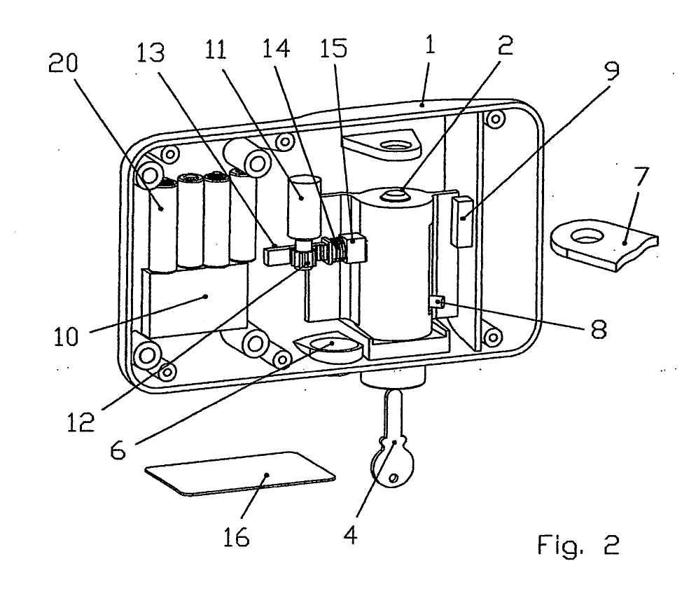

FIG. 2 is a perspective view of the interior of the lock of FIG. 1 with a back plate removed;

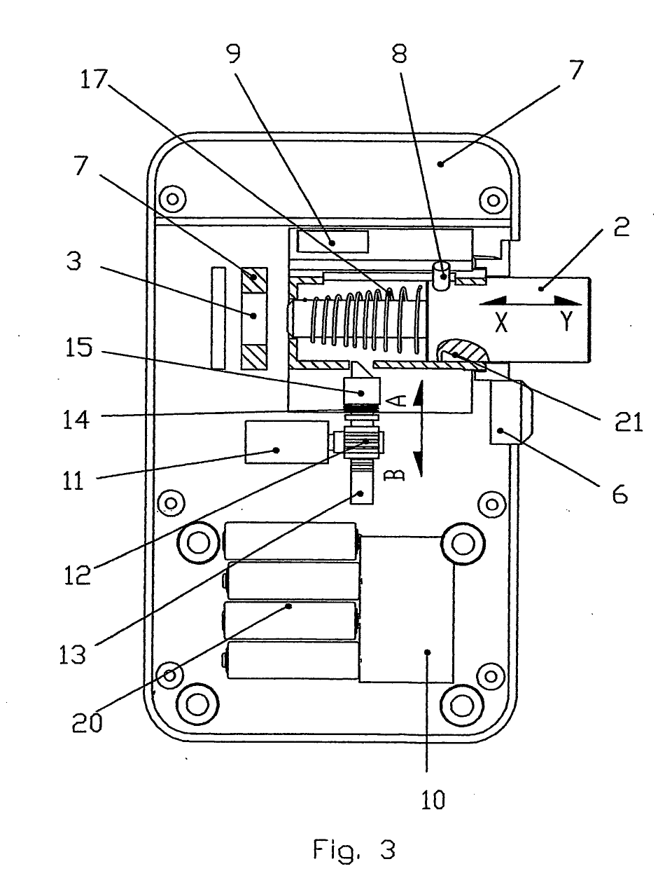

FIG. 3 is a rear elevation of the lock, with a cover plate removed, latched open;

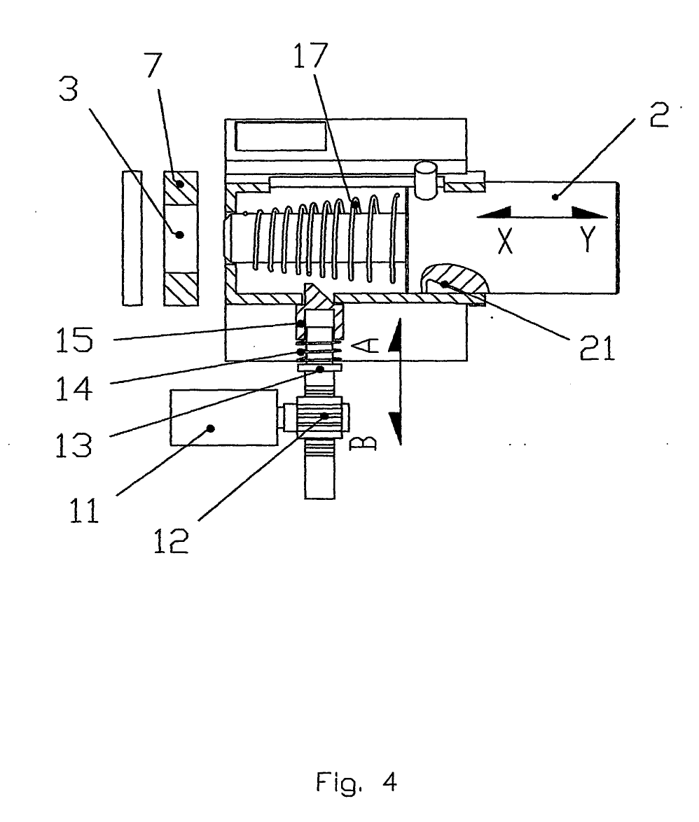

FIG. 4 is a part section rear elevation of the lock of FIGS. 1 to 3;

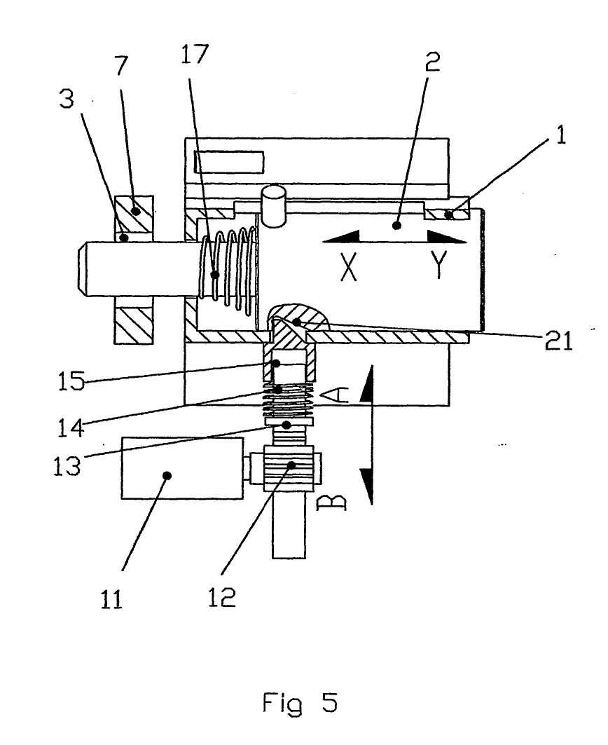

FIG. 5 is a part section rear elevation of the lock of FIGS. 1 to 4, latched closed;

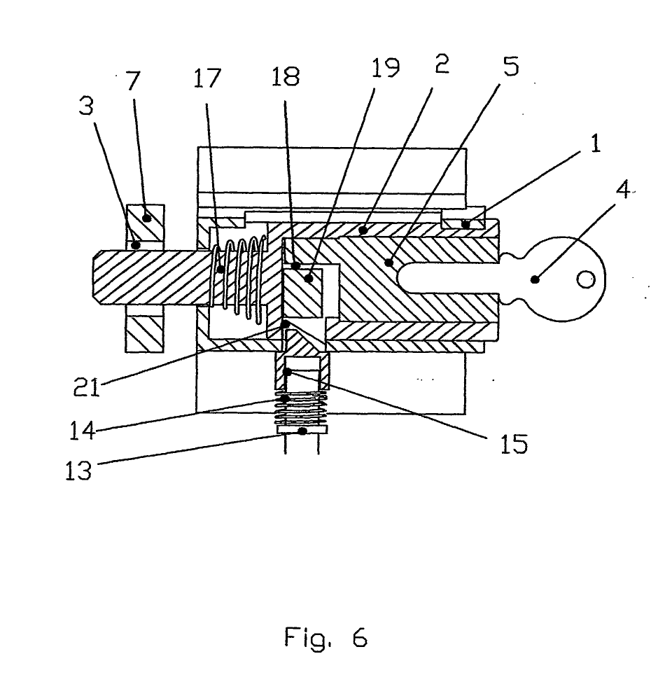

FIG. 6 is a part section rear elevation of the lock of FIGS. 1 to 5, latched closed and additionally showing an associated security cylinder and mechanical key;

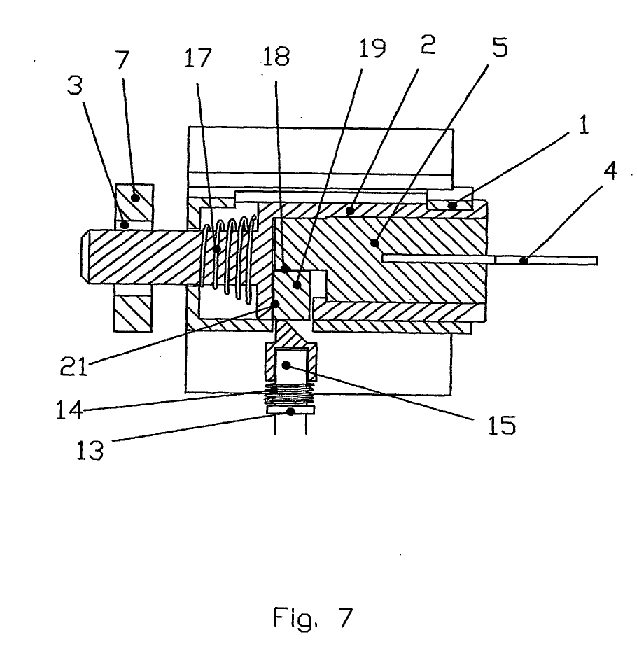

FIG. 7 is the part section rear elevation of FIG. 6, but with the security cylinder rotated and the lock primed to open;

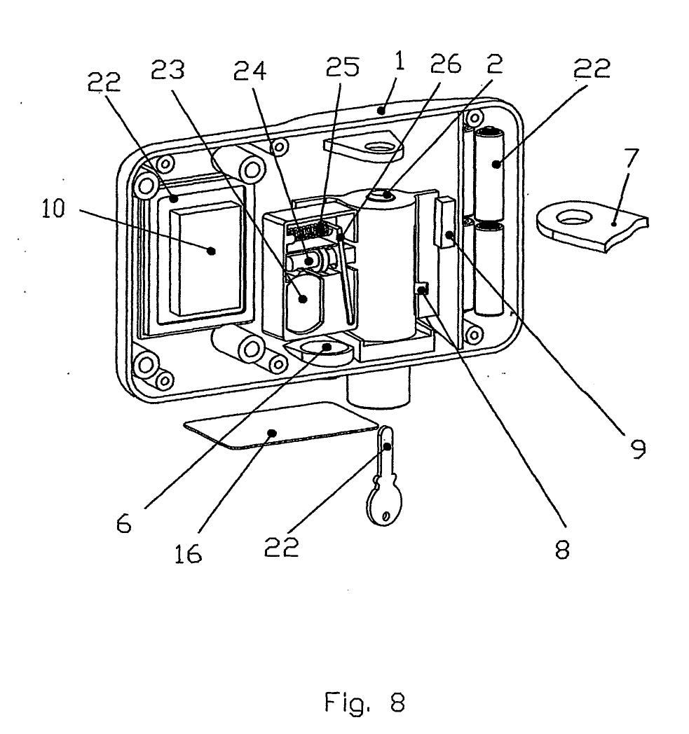

FIG. 8 is a rear perspective view of the interior of a lock in accordance with a second aspect of the invention;

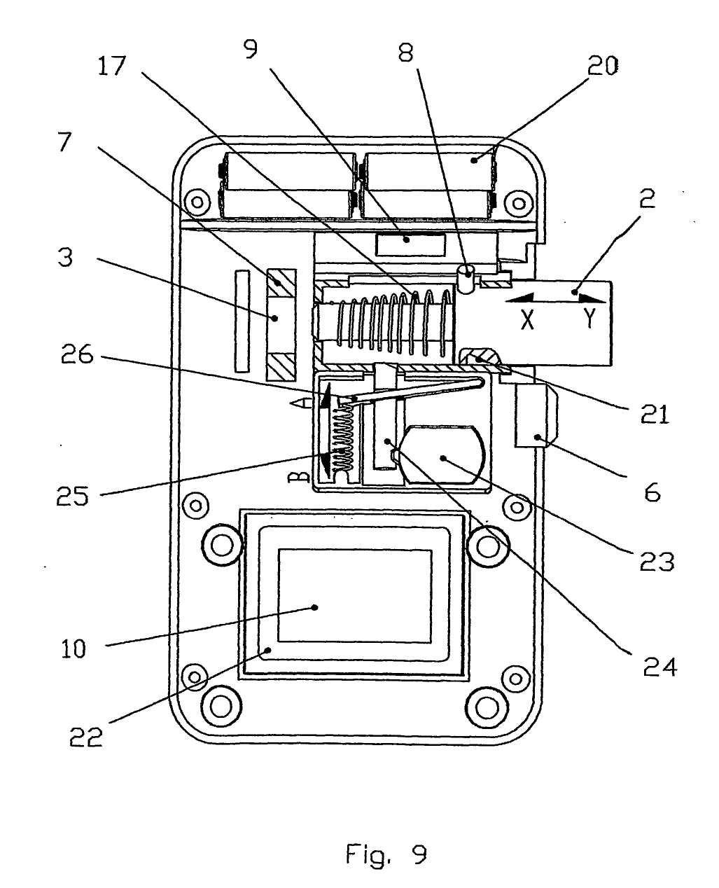

FIG. 9 is a rear elevation of the lock of FIG. 8 latched open;

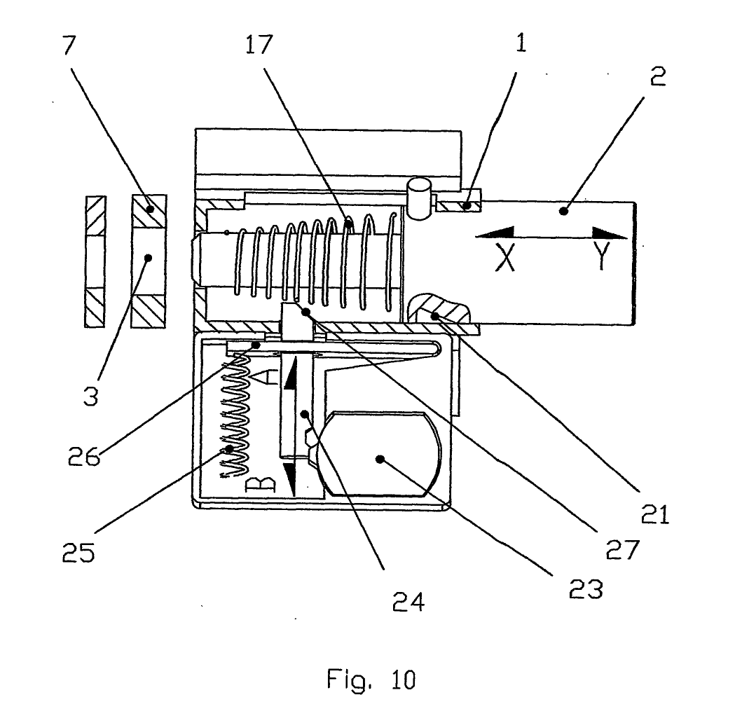

FIG. 10 is a part section rear elevation of the lock of FIGS. 8 and 9;

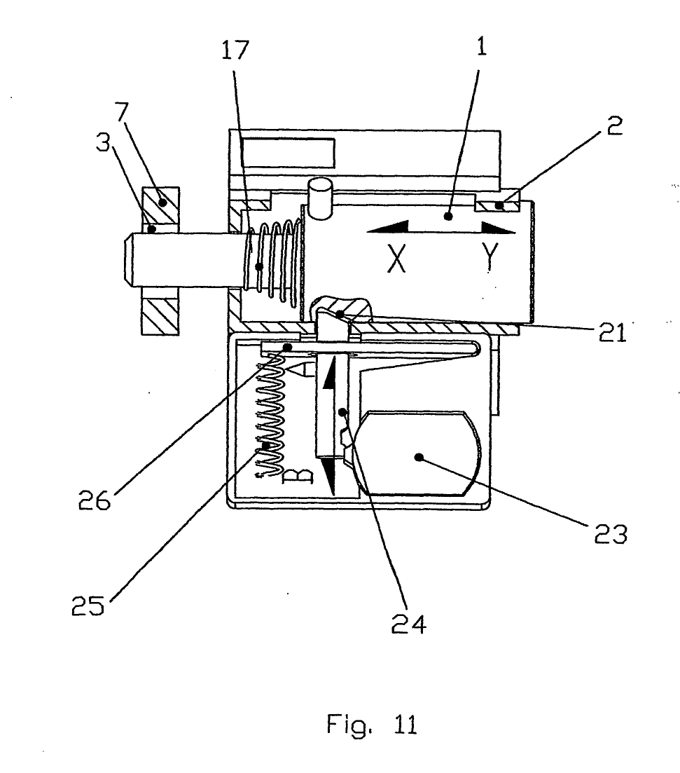

FIG. 11 is a part section rear elevation of the lock of FIGS. 8,9 and 10 latched closed;

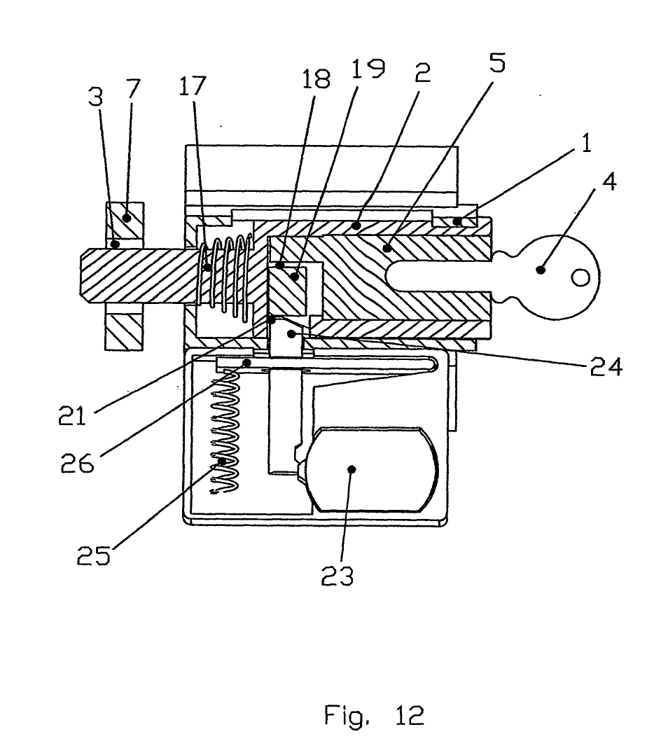

FIG. 12 is a part section rear elevation of the lock of FIGS. 8 to 11, latched closed, additionally showing an associated security cylinder and mechanical key; and

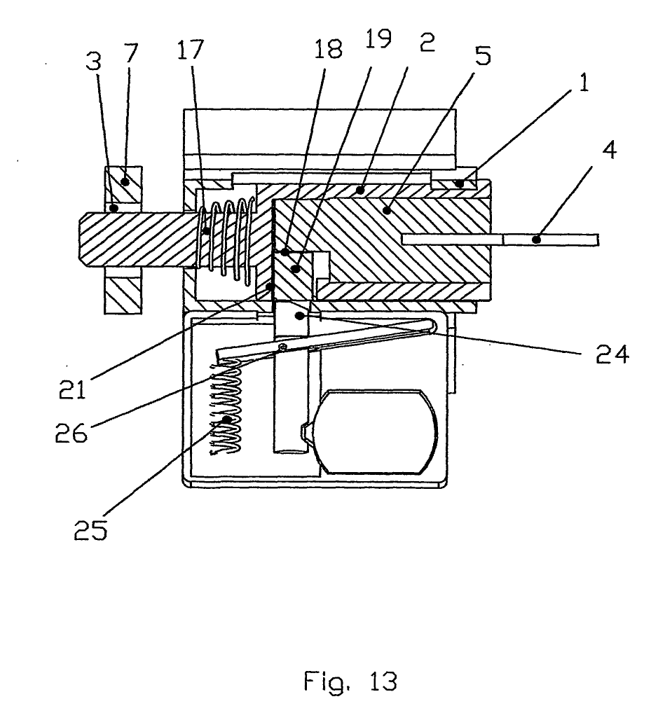

FIG. 13 is a part section rear elevation of FIG. 12 but with the security cylinder rotated and the lock primed to open.

Referring to FIG. 1, a lock in accordance with the present invention comprises a lock case 1 illustrated mounted on one door of a cupboard having a bolt 2 therein for engaging with a keep in the form of staple 7 mounted to the other door of the cabinet. Although shown mounted to a door, the lock could alternatively be mounted to a fixed door jam for receiving a keep mounted to a door, gate or the like.

Referring to FIG. 2, there is shown a perspective view inside the cover 1 of the lock, the open face of which would normally be closed by a back plate, which has been removed for clarity.

The lock comprises a bolt 2 which as seen in FIG. 3 extends through the bottom of the cover so that it may be actuated by a user. At its upper end the bolt 2 engages with aperture 3 of staple 7 locking it in place. The bolt 2 is physically operated by a user pushing on the exposed end of the bolt protruding through the casing. Operation of the bolt is controlled by a motorised actuator and a linkage 14, 15, which motorised actuator 11 is controlled by electronic circuitry 10 powered by batteries 20. The circuitry 10 is arranged to receive an authorisation signal from a ‘smart card’ 16 transmitting a signal to antenna 6 connected: to the circuitry 10. The operation of the lock in accordance with the first embodiment of the invention is described below with reference to FIGS. 1 to 7.

Lock case 1 and staple 7 are installed on a cabinet or gates or doors so that security bolt 2 is aligned with aperture 3 in staple 7. Authorised individuals on approaching lock case 1 manually depress security bolt 2 into lock case 1 in the directions of arrow X shown on FIG. 3, so that magnet 8 is aligned to sensor 9, which when activated sends a signal to circuitry 10, to ‘wake up’ its integral transceiver. On release of pressure security bolt 2, under pressure from spring 17, returns to open position in direction of arrow Y.

The duration of the ‘wake up’ of the electronic circuitry is timed to allow a signal from an authorised electronic key 16, held in close proximity to antenna 6, to be read by the transceiver element of control circuit 10. On receipt of this signal, the electronic control circuit 10, powered by battery pack 20 (or in an alternative embodiment by external power) controls the motorised actuator 11, coupled to pinion 12, to drive rack 13 and deadlock 15, in direction of arrow A, shown on FIG. 3, to the position shown in FIG. 4. In this position, the lock is primed and ready to latch closed.

When security bolt 2 is manually depressed into lock case 1 in direction X shown on FIG. 4, deadlock 15 is engaged by bolt 2, and under pressure from spring 14, is displaced in the direction of arrow B, shown on FIG. 4. Free play between deadlock 15 and rack 13 allows for this displacement. Bolt 2 is further manually depressed until notch 21 in bolt 2 aligns with matching profile on the end of the deadlock 15, allowing deadlock 15 under pressure from spring 14 to move in direction of arrow A, in to position shown on FIG. 5. In this position, the lock is latched closed, with bolt 2 engaged in aperture 3 of staple 7. Electronic circuitry 10 automatically switches off to go into ‘sleep mode’. This completes the locking cycle.

Unlocking is similar in principle to the early stages of locking, in that the ‘wake up’ procedure is followed thus:

Authorised individuals on approaching lock case 1 manually depress security bolt 2, into lock case 1, in direction of arrow X shown on FIG. 3, so that magnet 8 is aligned to sensor 9, which when activated sends a signal to circuitry 10 to ‘wake up’ its integral transceiver. On release of pressure by the user the security bolt 2, under pressure from spring 17, returns to the latched position in the direction of arrow Y of FIG. 5.

As before, the duration of the ‘wake up’ of the electronic circuitry is timed to allow a signal from an authorised presented electronic key 16, held in close proximity to antenna 6 to be read by the transceiver element of control circuit 10. On receipt of this signal electronic control circuit 10, powered by battery pack 20, or by external power, controls motorised actuator II coupled to pinion 12, to drive rack 13 and deadlock 15, in the direction of arrow B shown on FIG. 4, to position shown in FIG. 3.

Bolt 2 is now automatically released and under pressure from spring 17 moves in direction of arrow Y, as shown in FIG. 4. In this position, the lock is latched open and the circuitry is automatically switched off and goes into ‘sleep mode’ again.

Also incorporated into security bolt 2 is a mechanical security cylinder to provide manual access, and override, to give access in the event of failure to the electronic element.

FIG. 6 is a part sectioned view to show the internal mechanism of the mechanical override.

The manual unlocking procedure is:

With the lock in the latch closed position, an authorised key 4 is manually inserted into the security cylinder S. When key 4 is rotated in the require direction, cam face 18 of bolt 2, displaces follower 19, which displaces deadlock 15 into the position shown in FIG. 7. In this position, bolt 2 is free to disengage and under pressure from spring 17, can be released into the unlocked position (direction of arrow Y shown on FIG. 3).

Referring now to FIGS. 8 to 13, there is illustrated a further embodiment of the invention which is identical to that described above with references to FIGS. 2 to 7, except that in this embodiment the batteries 22 have been relocated within the cover to permit a keypad 22 to be inserted, with the circuitry 10 now mounted on the back of the keypad 22. The keypad provides an alternative way of inputting data to the lock permitting a user to insert a code without the requirement to have a card 16. This may be particularly advantageous if the lock is to be operated in unplanned circumstances, for example if the lock is mounted on a remote site, for example an electricity substation or water pumping station, where an operative may arrive at the site, perhaps in an emergency situation, without first acquiring an appropriate key. In this case, he may simply be given the appropriate code over the telephone. It will be appreciated that the keypad of this embodiment could equally be incorporated in the lock described with reference to FIGS. 2 to 7.

In the embodiments illustrated in FIGS. 8 to 13, the motorised actuator 11, pinion 12, rack 13, spring 14 and deadlock 15 of the FIGS. 2 to 7 embodiment are replaced by a piezoelectric actuator 23, modified deadlock 24, spring 25 and member 26.

In all other respects, the lock of FIGS. 8 to 13 is actuated and functions in the same manner as the lock illustrated in FIGS. 2 to 7, however the piezoelectric actuator arrangement, illustrated in FIGS. 8 to 13, enables the power consumption of the lock to be further reduced because the piezoelectric actuator may draw a current of only 7 μA.

Referring now to the operation of the lock of FIGS. 7 to 13, on approaching the open lock, depicted in FIG. 9, the user pushes the bolt 2 which wakes up the circuitry 10 in the same manner as previously described. In this embodiment though the deadlock has a modified face 27 and, as illustrated in FIGS. 10 and 11, this face 27 engages with the bolt 2 as the bolt 2 is pushed into the lock, causing the deadlock 24 to be forced in the direction of arrow B with member 26 compressing spring 25.

The circuitry 10, now awake, activates the piezoelectric actuator 23 which engages a notch in a deadlock 24 and retains the deadlock in the position indicated in FIG. 9. When the bolt 2 is subsequently released, it is free to move in the direction Y, thus the lock cannot be locked. The piezoelectric actuator is a two stage device and will continue to engage the deadlock even when after a predetermined period of time the circuitry 10 returns to its sleep mode and the piezoelectric actuator 23 is de-energized.

In contrast, if an authorised individual approaches the lock, then with the bolt 2 pushed into the lock case 1 in the direction of arrow X, he enters the correct code on the keypad 22, or passes an authorised card 16 by the antenna 6, the lock identifies an authorised user and the circuitry 10 causes the servo 23 to release deadlock 24. The deadlock 24 then returns under the action of the spring 25 and member 26 to the position indicated in FIG. 11, engaging the bolt 2 as it is released by the user. Thus, the bolt is secured in place as shown and the lock is then locked.

Unlock is similar in principle to the early stages of locking in that the wake up procedure is again followed by depressing bolt 2. Then entering the correct code in the keypad or passing an authorised card by the antenna 6, the circuitry 10 actuates actuator 23 such that further insertion of the bolt 2 forces the deadlock in the direction of arrow B until it is retained by the actuator 23, permitting the bolt to then be fully withdrawn in the direction of arrow Y under the force of the spring 17, thus releasing the staple 7.

The bolt 2 may additionally comprise a security cylinder 5 which can be operated by the key 4 shown in FIGS. 12 and 13. As before, operation of the key causes cam face 18 and follower 19 to protrude into the notch 21 pushing the deadlock out of the notch and thus releasing the bolt.

In all the embodiments depicted in FIGS. 1 through to 13, the dimensions of the bolt 2 and the staple 7 and their position within the lock case I are such that in combination with the dimensions of the lock case I a grinding wheel would be required to penetrate in excess of 20 mm into the lock case to sever the bolt or the staple 7. Furthermore, the lock case is formed of hardened steel with tungsten rods (not shown) attached to the inside of the cover (1). Additionally, or alternatively, layers of dissimilar materials such as ceramic and plastic may be molded on the inside of the cover 1 to combat cutting by grinding disks.

The above description relates to two particular locking arrangements. It will be evident to one skilled in the art that other modifications or alternative arrangements will be within the scope of the claims.

1. A lock, comprising: a lock mechanism arranged to receive and lock to an associated keep, characterised in that the lock comprises an outer cover which extends over both the lock mechanism and the keep when the keep is locked to the lock and in that the cover prevents access to both the lock mechanism and the keep.

2. The lock of claim 1, wherein those components of the lock mechanism which retain the keep in a locked position within the lock are located within the lock, and the lock cover is profiled such that a cutting/grinding disk extending in excess of approximately 20 mm from the body of a cutter would be required to sever those components and release the keep

3. The lock of claim 1, wherein the cover comprises dissimilar materials selected to resist cutting by a cutting disk.

4. The lock of claim 1, wherein the lock cover comprises ceramic inserts attached thereto.

5. The lock of claim 1, wherein the lock cover comprises hardened steel inserts attached thereto.

6. The lock of claim 1, wherein the lock cover is cast and hardened on at least one surface thereof.

7. The lock of claim 1, wherein the cover protects the lock from the weather.

8. The lock of claim 1, wherein the lock mechanism comprises electronic circuitry and mechanical elements controlled by the electronic circuitry.

9. The lock of claim 8, wherein the circuitry comprises a keypad aligned with an aperture in the cover permitting the lock to be operated when a correct code is entered on the keypad.

10. The lock of claim 8, wherein the circuitry comprises a receiver for receiving a signal externally of the cover and permits operation of the lock when an authorisation signal is received.

11. The lock of claim 8, wherein a mechanical linkage extends through the cover of the lock such that the linkage can be activated by a user, wherein the lock is arranged such that on receipt of a correct code or signal, the electronic circuit enables the lock to be released by the user operating the mechanical linkage such that the energy required to lock or release the lock is supplied by the user.

12. The lock of claim 11, wherein the circuitry comprises a wake up mode which is activated by the user operating the mechanical linkage.

13. The lock of claim 11, wherein the mechanical linkage comprises a cylinder lock arranged to release the lock manually when operated by the correct key.

14. A The lock of claim 8, wherein the electronic circuitry controls an actuator which releases the mechanical mechanism.

15. The lock 14, wherein the actuator is a piezoelectric actuator.

16. (canceled)

17. The lock of claim 9, wherein the circuitry comprises a receiver for receiving a signal externally of the cover and permits operation of the lock when an authorisation signal is received.

18. The lock of claim 9, wherein a mechanical linkage extends through the cover of the lock such that the linkage can be activated by a user, wherein the lock is arranged such that on receipt of a correct code or signal, the electronic circuit enables the lock to be released by the user operating the mechanical linkage such that the energy required to lock or release the lock is supplied by the user.

19. The lock of claim 10, wherein a mechanical linkage extends through the cover of the lock such that the linkage can be activated by a user, wherein the lock is arranged such that on receipt of a correct code or signal, the electronic circuit enables the lock to be released by the user operating the mechanical linkage such that the energy required to lock or release the lock is supplied by the user.

20. The lock of claim 11, wherein the circuitry comprises a wake up mode which is activated by the user operating the mechanical linkage.
